(19) United States
(12) Patent Application Publication
(10) Pub. No.: US 2025/0097960 A1
(43) Pub. Date: Mar. 20, 2025

(54) CHANNEL TRANSMISSION METHOD AND APPARATUS, AND STORAGE MEDIUM

(71) Applicant: Beijing Xiaomi Mobile Software Co., Ltd., Beijing (CN)

(72) Inventors: Wensu ZHAO, Beijing (CN); Qun ZHAO, Beijing (CN)

(21) Appl. No.: 18/727,193

(22) PCT Filed: Jan. 10, 2022
(86) PCT No.: PCT/CN2022/070975

§ 371 Date: Jul. 8, 2024

(51) Int. Cl. H04W 72/25; H04L 1/06

(52) U.S. Cl. CPC H04W 72/25; H04L 1/0668

(57) ABSTRACT

A channel transmission method is performed by one or more receiving devices for a sidelink, and includes: in an unlicensed frequency band, for each of the one or more receiving devices, mapping a physical sidelink feedback channel (PSFCH) sequence transmitted by the receiving device to a plurality of interlaced physical resource blocks (IRBs), wherein the plurality of IRBs belong to a same IRB index; and transmitting, by the plurality of IRBs, the PSFCH sequence to a transmitting device for the sidelink.

### CROSS-REFERENCE TO RELATED APPLICATIONS

This application is a U.S. national stage application of International Application No. PCT/CN2022/070975, filed on Jan. 10, 2022, the content of which is hereby incorporated by reference in its entirety.

### TECHNICAL FIELD

The present disclosure relates to the technical field of communication, in particular to channel transmission methods and apparatuses, and storage media.

### BACKGROUND

With continuous emergence of requirements of various new services and new applications, the requirement of terminal sidelink communication on performance such as transmission bandwidth, communication speed, communication delay, reliability, and scalability becomes higher and higher. If relying on limited licensed spectrum, it may not be able to meet diverse application scenarios and requirements in the future. Therefore, it is necessary to research and design a terminal sidelink-unlicensed technology that can be applied in an unlicensed frequency band.

In the unlicensed frequency band, it is necessary to meet an Occupancy Channel Band (OCB) requirement, that is, each transmission needs to occupy 80% of a Listen Before Talk (LBT) subband bandwidth. Taking a subband bandwidth of 20 MHz (megahertz) as an example, at least 16 MHz or more bandwidth needs to be occupied to meet the OCB requirement.

At present, channels such as Physical Sidelink Share Channel (PSSCH) and Physical Sidelink Feedback Channel (PSFCH) in a sidelink unlicensed frequency band system are according to the interlaced physical resource block (IRB) structure, that is, a PSFCH needs to occupy more IRBs in one IRB index to meet the OCB requirement. However, in Release 16 (R16) sidelink, the PSFCH only occupies one physical resource block (PRB), which cannot meet the OCB requirement on the unlicensed frequency band of the sidelink.

### SUMMARY

To overcome the problems in the related art, in embodiments of the present disclosure, channel transmission methods and apparatuses, and storage media are provided.

According to the first aspect of the embodiments of the present disclosure, a channel transmission method is provided, performed by a receiving device for a sidelink, and includes:
in an unlicensed frequency band, mapping a physical sidelink feedback channel (PSFCH) sequence transmitted by the one or more receiving devices to a plurality of interlaced resource blocks (IRBs), where the plurality of IRBs belong to a same IRB index; and
transmitting, by the plurality of IRBs, the PSFCH sequence to a transmitting device for the sidelink.

According to the second aspect of the embodiments of the present disclosure, a channel transmission method is provided, performed by a transmitting device for a sidelink, and includes:
in an unlicensed frequency band, receiving a physical sidelink feedback channel (PSFCH) sequence that is transmitted by a receiving device for the sidelink through a plurality of interlaced resource blocks (IRBs), where the plurality of IRBs belong to a same IRB index.

According to the third aspect of the embodiments of the present disclosure, a channel transmission apparatus is provided, applied to a receiving device for a sidelink, and includes:
a mapping module, configured to, in an unlicensed frequency band, map a physical sidelink feedback channel (PSFCH) sequence transmitted by the one or more receiving devices to a plurality of interlaced resource blocks (IRBs), where the plurality of IRBs belong to a same IRB index; and
a transmitting module, configured to transmit, by the plurality of IRBs, the PSFCH sequence to a transmitting device for the sidelink.

According to the fourth aspect of the embodiments of the present disclosure, a channel transmission apparatus is provided, applied to a transmitting device for a sidelink, and includes:
a receiving module, configured to, in an unlicensed frequency band, receive a physical sidelink feedback channel (PSFCH) sequence that is transmitted by a receiving device for the sidelink through a plurality of interlaced resource blocks (IRBs), where the plurality of IRBs belong to a same IRB index.

According to the fifth aspect of the embodiments of the present disclosure, a channel transmission device is provided, and includes:
one or more processors; and
one or more memories storing instructions executable by the one or more processors;
where the one or more processors are configured to execute the instructions to implement the channel transmission method according to the first aspect.

According to the sixth aspect of the embodiments of the present disclosure, a channel transmission device is provided, and includes:
one or more processors; and
one or more memories storing instructions executable by the one or more processors;
where the one or more processors are configured to execute the instructions to implement the channel transmission method according to the second aspect.

The technical solutions provided by the embodiments of the present disclosure can include following beneficial effects.

In the embodiments of the present disclosure, in the unlicensed frequency band of the sidelink, the receiving device can map the corresponding PSFCH sequence to the plurality of IRBs, where the plurality of IRBs belong to the same IRB index. Therefore, the receiving device can transmit the PSFCH sequence to the transmitting device of the sidelink through the plurality of IRBs. In the present disclosure, the PSFCH sequence can be transmitted through the plurality of IRBs belonging to the same IRB index in the unlicensed frequency band of the sidelink, which meets the OCB requirement, and improves the availability of the unlicensed frequency band of the sidelink.

It is to be understood that the above general descriptions and the below detailed descriptions are merely exemplary and explanatory, and are not intended to limit the present disclosure.

### BRIEF DESCRIPTION OF DRAWINGS

The accompanying drawings, which are incorporated in and constitute a part of this specification, illustrate examples consistent with the present disclosure and, together with the description, serve to explain the principles of the present disclosure.

FIGS. 1A to 1B are schematic diagrams of an IRB structure according to an embodiment.

FIG. 2 is a schematic diagram of a relationship between IRB and an RB set according to an embodiment.

FIG. 3 is a flowchart of a channel transmission method according to an embodiment.

FIG. 4 is a schematic diagram of a PSFCH sequence mapping manner according to an embodiment.

FIG. 5 is a flowchart of another channel transmission method according to an embodiment.

FIG. 6 is a schematic diagram of another PSFCH sequence mapping manner according to an embodiment.

FIG. 7 is a flowchart of another channel transmission method according to an embodiment.

FIG. 8 is a flowchart of another channel transmission method according to an embodiment.

FIG. 9 is a schematic diagram of another PSFCH sequence mapping manner according to an embodiment.

FIG. 10 is a flowchart of another channel transmission method according to an embodiment.

FIG. 11 is a flowchart of another channel transmission method according to an embodiment.

FIG. 12 is a schematic diagram of another PSFCH sequence mapping manner according to an embodiment.

FIG. 13 is a flowchart of another channel transmission method according to an embodiment.

FIG. 14 is a schematic diagram of another PSFCH sequence mapping manner according to an embodiment.

FIG. 15 is a flowchart of another channel transmission method according to an embodiment.

FIG. 16 is a flowchart of another channel transmission method according to an embodiment.

FIG. 17 is a schematic diagram of another PSFCH sequence mapping manner according to an embodiment.

FIG. 18 is a flowchart of another channel transmission method according to an embodiment.

FIG. 19 is a flowchart of another channel transmission method according to an embodiment.

FIG. 20 is a flowchart of another channel transmission method according to an embodiment.

FIG. 21 is a flowchart of another channel transmission method according to an embodiment.

FIG. 22 is a block diagram of a channel transmission apparatus according to an embodiment.

FIG. 23 is a block diagram of a channel transmission apparatus according to an embodiment.

FIG. 24 is a schematic structural diagram of a channel transmission apparatus according to an embodiment.

### DETAILED DESCRIPTION

Embodiments will be described in detail here with the examples thereof expressed in the drawings. When the following descriptions involve the drawings, like numerals in different drawings represent like or similar elements unless stated otherwise. Implementations described in the following embodiments do not represent all implementations consistent with the present disclosure. On the contrary, they are examples of an apparatus and a method consistent with some aspects of the present disclosure described in detail in the appended claims.

The term used in the present disclosure is for the purpose of describing particular embodiments only and is not intended to limit the present disclosure. As used in the present disclosure and the appended claims, the singular forms “a”, “an” and “the” are intended to include the plural forms as well, unless the context clearly indicates otherwise. It should further be understood that the term “and/or” as used herein refers to and includes any and all possible combinations of at least one of the associated listed items.

It should be understood that although the terms first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, the word “if” as used herein can be interpreted as “at the time of”, “when” or “in response to determining”.

Before introducing the channel transmission method provided in the present disclosure, the concept of Interlaced Resource Block (IRB), and the relationship between the IRB and a Resource Block (RB) set involved in the present disclosure are first introduced.

In a New Radio-Unlicensed (NR-U) system, the IRB is introduced, that is, there are M resource blocks between two consecutive available resource blocks. Physical Resource Block (PRB) indexes for IRBs belonging to the same IRB index m are {m, m+M, m+2M, m+3M, . . . }, where m∈{0, 1, . . . , M−1}.

In the NR-U system, corresponding IRB structures are defined for 15 kHz (kilohertz) Sub-Carrier Space (SCS) and 30 kHz SCS, as shown in Table 1. When the SCS is 15 kHz, the value of M can be 10, and when SCS is 30 kHz, the value of M can be 5.

TABLE 1

| μ | M |
|---|---|
| 0 (corresponding SCS is 15 kHz) | 10 |
| 1 (corresponding SCS is 30 kHz) | 5 |

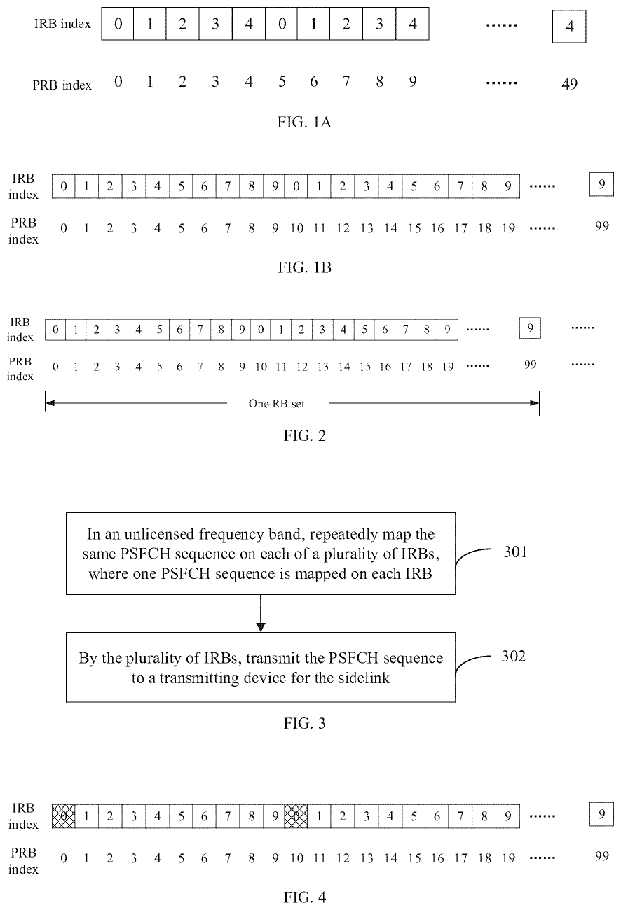

As shown in FIG. 1A, when SCS is 30 kHz, the value of M is 5, that is, for the same IRB index, there can be 5 interlace indexes. Where the PRB indexes of IRBs included in the IRB index 0 are {0, 5, 10, 15, 20, 25, 30, 35, 40, 45}.

As shown in FIG. 1B, when SCS is 15 KHz, the value of M is 10, that is, for the same IRB index, there can be 10 interlace indexes. Where the PRB indexes of the IRBs included in the IRB index 0 are {0, 10, 20, 30, 40, 50, 60, 70, 80, 90}.

In addition, in the NR-U system, a bandwidth of one LBT subband is generally 20 MHz, which is collectively referred to as an RB set. The entire carrier bandwidth is divided into a plurality of RB sets, and a network side maps the RB sets to a BWP (Bandwidth Part) by configuring the BWP. The protocol defines that the BWP configured by the network side must contain an integer number of RB sets. As shown in FIG. 2, SCS is 15 kHz, the bandwidth of the LBT subband is 20 MHz, M is 10, that is, there are 10 IRB indexes, and each RB set includes 100 RBs.

In order to meet the OCB requirement for the unlicensed frequency band of the sidelink, the following channel transmission method are provided in the present disclosure. The channel transmission method provided in the embodiments of the present disclosure is introduced from a receiving device below.

The first method is to map the PSFCH sequence to the plurality of IRBs for the same IRB index.

The embodiments of the present disclosure provide a channel transmission method. As shown in FIG. 3, FIG. 3 is a flowchart of a channel transmission method according to an embodiment. The method can be performed by a receiving device for a sidelink. It should be noted that the receiving device refers to a data receiving device. The method may include the following steps 301-302.

In step 301, in an unlicensed frequency band, the same PSFCH sequence is repeatedly mapped on each of a plurality of IRBs, where one PSFCH sequence is mapped on each IRB.

In the embodiments of the present disclosure, the plurality of IRBs belong to the same IRB index.

In an embodiment, the number of the plurality of IRBs can be 10. The number of the plurality of IRBs belonging to the same IRB index can also be other positive integer values, which is not limited in the present disclosure.

In the embodiments of the present disclosure, the PSFCH is used for the receiving device to provide feedback on Hybrid Automatic Repeat reQuest Acknowledgment (HARQ-ACK) result(s) to the transmitting device. The receiving device can repeatedly map the PSFCH sequence to each IRB belonging to the same IRB index.

In an embodiment, the PSFCH sequence adopts a first format. The first format is at least used to indicate that a length of the PSFCH sequence is 12. In an embodiment, the first format can refer to format 0.

In step 302, by the plurality of IRBs, the PSFCH sequence is transmitted to a transmitting device for the sidelink.

For example, as shown in FIG. 4, if resources allocated to the PSFCH sequence transmitted by the receiving device are on the plurality of IRBs included in the IRB index 0, the receiving device can repeatedly transmit a PSFCH format-0 sequence with a length of 12 on 10 IRBs {0, 10, 20, 30, 40, 50, 60, 70, 80, 90} corresponding to the IRB index 0.

In the above embodiment, the PSFCH sequence can be repeatedly transmitted through the plurality of IRBs belonging to the same IRB index in the unlicensed frequency band for the sidelink, which meets the OCB requirement. That is, in the unlicensed frequency band, each transmission occupies a preset proportion of the bandwidth of the LBT subband, thereby improving the availability of the unlicensed frequency band of the sidelink.

In some embodiments, considering that the PSFCH sequence previously occupied 1 PRB, if extended to 10 PRBs, the PSFCH sequence for one terminal would occupy 10 PRBs. Originally, 10 PRBs could be occupied by the PSFCH sequences for 10 terminals. It would cause a decrease in user capacity. To address the technical problem, the present disclosure further provides a multi-user multiplexing solution, where PSFCH sequences respectively corresponding to a plurality of receiving devices can multiplex the plurality of IRBs belonging to the same IRB index.

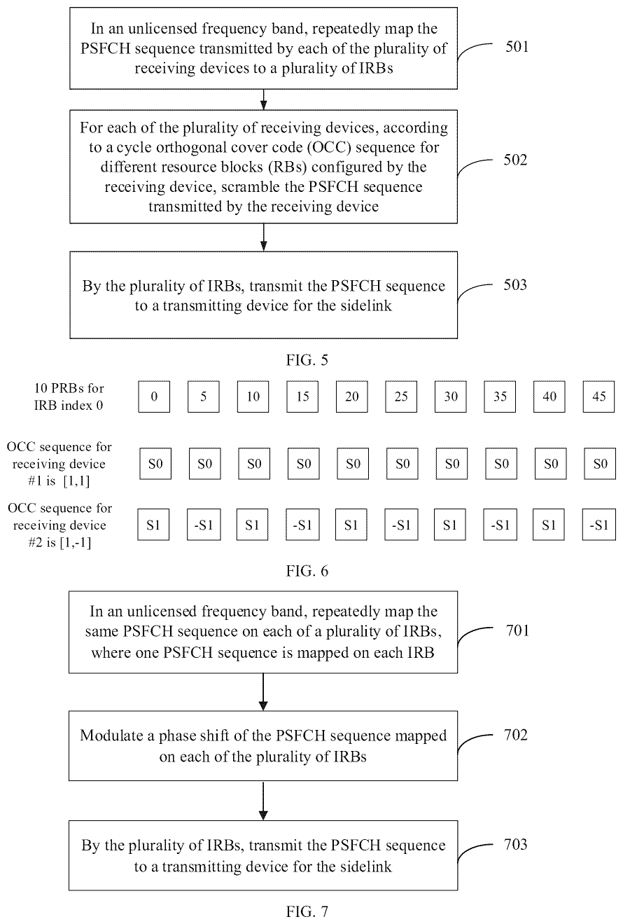

Referring to FIG. 5, FIG. 5 is a flowchart of a channel transmission method according to an embodiment. The method can be performed by a plurality of receiving devices for a sidelink. The method may include the following steps 501 to 503.

In step 501, in an unlicensed frequency band, the PSFCH sequence transmitted by each of the plurality of receiving devices is repeatedly mapped to a plurality of IRBs.

In the embodiments of the present disclosure, the plurality of IRBs belong to the same IRB index.

In an embodiment, the number of the plurality of IRBs can be 10. Of course, the number of the plurality of IRBs belonging to the same IRB index can also be other values, which is not limited in the present disclosure.

In an embodiment, the PSFCH sequence adopts a first format. The first format is at least used to indicate that a length of the PSFCH sequence is 12. In an embodiment, the first format can refer to format 0.

In the embodiments of the present disclosure, each IRB can be used to transmit the PSFCH sequence transmitted by each of the plurality of receiving devices, and the PSFCH sequence transmitted by each receiving device can be repeatedly mapped to each IRB.

In step 502, for each of the plurality of receiving devices, according to a cycle orthogonal cover code (OCC) sequence for different resource blocks (RBs) configured by the receiving device, the PSFCH sequence transmitted by the receiving device is scrambled.

In the embodiments of the present disclosure, a cycle OCC can be used for adjacent IRBs to scramble the PSFCH sequence transmitted by each receiving device. The OCC sequence is for RB-level, which can be referred to as a cycle OCC sequence for different RBs.

In the embodiments of the present disclosure, the length of the cycle OCC sequence for different RBs configured by each receiving device can be N, where N can indicate the number of terminals multiplexed on each IRB, i.e., the number of PSFCH sequences transmitted on each IRB. N can be a positive integer greater than 1, such as N=2 or 4. When N=2, it supports multiplexing of two receiving devices, and when N=4, it supports multiplexing of four receiving devices.

In step 503, by the plurality of IRBs, the PSFCH sequence is transmitted to a transmitting device for the sidelink.

For ease of understanding, further examples of the above process are provided below.

As shown in FIG. 6, assuming M is 5, where M represents the number of resource blocks between two consecutive interlaced resource blocks, in 10 PRBs belonging to IRB index 0, assuming that the PSFCH format-0 sequence to be transmitted by receiving device #1 is S0, and the PSFCH format-0 sequence to be transmitted by receiving device #2 is S1, receiving device #1 and receiving device #2 reuse OCC sequences in NR-U. The OCC sequence for different RBs configured by receiving device #1 is [1, 1] (i.e., the S0 sequence transmitted on every two IRBs is multiplied by this OCC sequence), and the OCC sequence for different RBs configured by receiving device #2 is [1, −1].

The PSFCH sequences transmitted by receiving device #1 on 10 IRBs belonging to IRB index 0 is {S0, S0, S0, S0, S0, S0, S0, S0, S0, S0}, the PSFCH sequence transmitted by receiving device #2 on 10 IRBs belonging to IRB index 0 is {S1, −S1, S1, −S1, S1, −S1, S1, −S1, S1, −S1}.

It should also be noted that the present disclosure does not limit the number of receiving devices for multiplexing, as long as the cycle OCC sequences for different RBs configured by different receiving devices are orthogonal.

For example, the number of receiving devices for multiplexing can be 4, and the cycle OCC sequence for different RBs configured by receiving device #1 can be [1, 1, 1, 1], the cycle OCC sequence for different RBs configured by receiving device #2 can be [1, −1, 1, −1], the cycle OCC sequence for different RBs configured by receiving device #3 can be [1, 1, −1, −1], and the cycle OCC sequence for different RBs configured by receiving device #4 can be [1, −1, −1, 1].

In the above embodiments, it is possible to meet the OCB requirement in the unlicensed frequency band of the sidelink, and support multiplexing for multiple receiving devices, relieving user capacity degradation and having high availability.

In some embodiments, referring to FIG. 7, FIG. 7 is a flowchart of a channel transmission method according to an embodiment. The method can be performed by a receiving device for a sidelink. The method may include the following steps 701 to 703.

In step 701, in an unlicensed frequency band, the same PSFCH sequence is repeatedly mapped on each of a plurality of IRBs, where one PSFCH sequence is mapped on each IRB.

In an embodiment, the number of the plurality of IRBs can be 10. Of course, the number of the plurality of IRBs belonging to the same IRB index can also be other values, which is not limited in the present disclosure.

In an embodiment, the PSFCH sequence adopts a first format. The first format is at least used to indicate a length of the PSFCH sequence, and the length of the PSFCH sequence can be 12. In an embodiment, the first format can refer to format 0.

In step 702, a phase shift of the PSFCH sequence mapped on each of the plurality of IRBs is modulated.

In the embodiments of the present disclosure, for each of the plurality of the IRBs, the phase shift can be determined according to a ranking of the IRB in the plurality of IRBs.

In an embodiment, a PSFCH format-0 sequence with a length of 12 is repeatedly transmitted on each IRB belonging to the same IRB index, and the PSFCH sequence is modulated by a phase shift α on each IRB. Assuming that the PSFCH sequence transmitted by the receiving device is S0, the phase shift of the PSFCH sequence can be modulated according to the following formula 1.

$$S 0 ( n ) = S 0 ( n ) {e}^{j α n} , \qquad Formula 1$$

$$where$$

$$n = 0 , 1 , … , 11$$

Where n represents the n-th IRB of the IRBs belonging to the same IRB index. Since the length of the PSFCH sequence is 12, the value of n ranges from 0 to 11.

In step 703, by the plurality of IRBs, the PSFCH sequence is transmitted to a transmitting device for the sidelink.

In the above embodiments, it is possible to meet the OCB requirement in the unlicensed frequency band of the sidelink, and modulate the phase shift for the PSFCH sequence, thereby improving communication performance and having high availability.

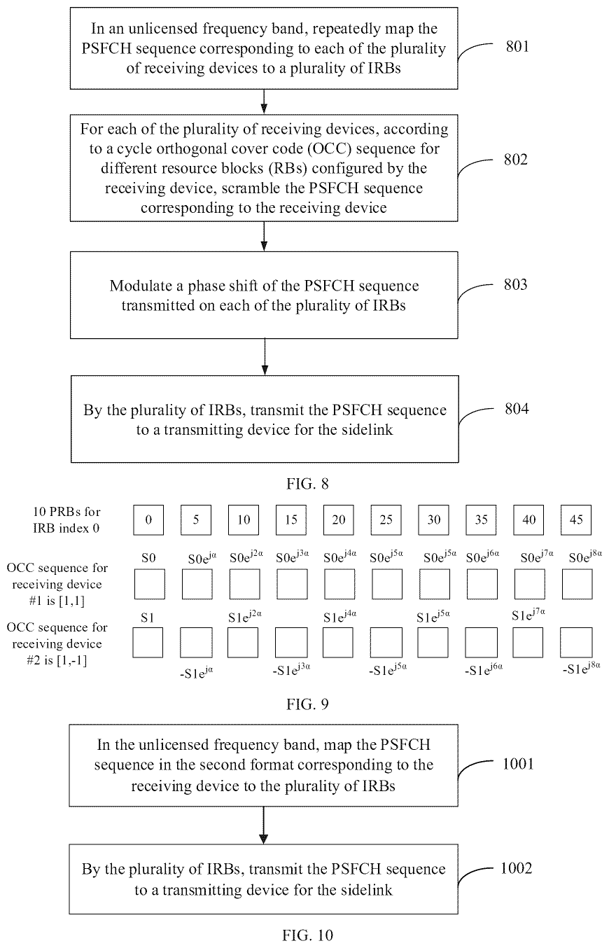

In some embodiments, referring to FIG. 8, FIG. 8 is a flowchart of a channel transmission method according to an embodiment. The method can be performed by a plurality of receiving devices for a sidelink. The method may include the following steps 801 to 804.

In step 801, in an unlicensed frequency band, the PSFCH sequence transmitted by each of the plurality of receiving devices is repeatedly mapped to a plurality of IRBs.

In the embodiments of the present disclosure, the plurality of IRBs belong to the same IRB index.

In an embodiment, the number of the plurality of IRBs can be 10. Of course, the number of the plurality of IRBs belonging to the same IRB index can also be other values, which is not limited in the present disclosure.

In an embodiment, the PSFCH sequence adopts a first format. The first format is at least used to indicate that a length of the PSFCH sequence is 12. In an embodiment, the first format can refer to format 0.

In the embodiments of the present disclosure, each IRB can be used to transmit the PSFCH sequence transmitted by each of the plurality of receiving devices, and the PSFCH sequence transmitted by each receiving device can be repeatedly mapped to each IRB.

In step 802, for each of the plurality of receiving devices, according to a cycle orthogonal cover code (OCC) sequence for different resource blocks (RBs) configured by the receiving device, the PSFCH sequence transmitted by the receiving device is scrambled.

In the embodiments of the present disclosure, the length of the cycle OCC sequence for different RBs configured by each receiving device is the same as the number N of PSFCH sequences transmitted on each IRB, where N is also the same as the number of receiving devices for multiplexing.

In step 803, a phase shift of the PSFCH sequence transmitted on each of the plurality of IRBs is modulated.

The method for modulating the phase shift is similar to step 702 above, which will not be repeated here.

In the embodiments of the present disclosure, the execution order of steps 802 and 803 is not limited. The PSFCH sequences corresponding to the plurality of receiving devices transmitted on each IRB can be scrambled first, and then the phase shift of the PSFCH sequences transmitted on each IRB can be modulated. Alternatively, the phase shift of the PSFCH sequences corresponding to the plurality of receiving devices transmitted on each IRB can be modulated first, and then the PSFCH sequences corresponding to the plurality of receiving devices transmitted on each IRB can be scrambled.

In step 804, by the plurality of IRBs, the PSFCH sequence is transmitted to a transmitting device for the sidelink.

For ease of understanding, further examples of the above process are provided below.

As shown in FIG. 9, assuming that M is 5, in the 10 IRBs belonging to IRB index 0, the PSFCH format-0 sequence to be transmitted by receiving device #1 is S0, and the PSFCH format-0 sequence to be transmitted by receiving device #2 is S1, and the OCC sequence for different RBs configured by receiving device #1 is [1, 1], and the OCC sequence for different RBs configured by receiving device #2 is [1, −1].

At this case, the PSFCH sequence transmitted by receiving device #1 on 10 IRBs belonging to IRB index 0 is {S0, S0e^{j1α}, S0e^{j2α}, S0 e^{j3α}, S0 e^{j4α}, S0 e^{j5α}, S0 e^{j6α}, S0 e^{j7α}, S0 e^{j8α}, S0 e^{j9α}}, and the PSFCH sequence transmitted by receiving device #2 on 10 IRBs belonging to IRB index 0 is {S1, −S1 e^{jα}, S1 e^{j2α}, −S1 e^{j3α}, S1 e^{j4α}, −S1 e^{j5α}, S1 e^{j6α}, −S1 e^{j7α}, S1 e^{j8α}, −S1 e^{j9α}}.

In the above embodiments, it is possible to meet the OCB requirement in the unlicensed frequency band of the sidelink, modulate the phase shift for the PSFCH sequence, and support multiplexing for the plurality of receiving devices, which reduces user capacity degradation, improves communication performance, and has high availability.

In some embodiments, referring to FIG. 10, FIG. 10 is a flowchart of a channel transmission method according to an embodiment. The method can be performed by a receiving device for a sidelink. The method may include the following steps 1001 to 1002.

In step 1001, in the unlicensed frequency band, the PSFCH sequence in the second format corresponding to the receiving device is mapped to the plurality of IRBs.

In the embodiments of the present disclosure, the plurality of IRBs belong to the same IRB index.

In an embodiment, the number of the plurality of IRBs can be 10. Of course, the number of the plurality of IRBs belonging to the same IRB index can also be other values, which is not limited in the present disclosure.

In the embodiments of the present disclosure, a new PSFCH sequence format, namely the second format, is provided. The second format is at least used to indicate that a length of the PSFCH sequence is a preset length, where the PSFCH sequence with the preset length supports being mapped to the plurality of IRBs belonging to the same IRB index.

In an embodiment, one IRB index includes 10 IRBs, and each IRB containing 12 Resource Elements (REs). Therefore, IRBs belonging to the same IRB index have a total of 120 REs, that is, there are 120 subcarriers. Correspondingly, the preset length of the PSFCH sequence can be 120, thereby achieving the goal of supporting the PFSCH sequence to be mapped onto 120 subcarriers of the plurality of IRBs belonging to the same IRB index.

In step 1002, by the plurality of IRBs, the PSFCH sequence is transmitted to a transmitting device for the sidelink.

In the above embodiments, a new PSFCH sequence format is provided that supports mapping to the plurality of IRBs belonging to the same IRB index, which also achieves the goal of meeting the OCB requirement in the unlicensed frequency band of the sidelink.

In some embodiments, referring to FIG. 11, FIG. 11 is a flowchart of a channel transmission method according to an embodiment. The method can be performed by a plurality of receiving devices for a sidelink. The method may include the following steps 1101 to 1103.

In step 1101, for each of the plurality of receiving devices, cycle shift is performed on the PSFCH sequence in the second format corresponding to the receiving device, to obtain a PSFCH sequence after cycle shift in the second format.

In the embodiments of the present disclosure, multi-user multiplexing is supported, that is, each IRB can be used to transmit PSFCH sequences in the second format corresponding to the plurality of receiving devices.

In an embodiment, cycle shift (CS) can be used to perform cycle shift on the PSFCH sequence in the second format corresponding to each receiving device transmitted on the same IRB. Assuming that one IRB supports the number of CS pairs is N′ and N′ is 6, multiplexing of 12 receiving devices is supported.

In step 1102, for each of the plurality of receiving devices, the PSFCH sequence after cycle shift in the second format corresponding to the receiving device is mapped to the plurality of IRBs.

In step 1103, by the plurality of IRBs, the PSFCH sequence is transmitted to a transmitting device for the sidelink.

For ease of understanding, further examples of the above process are provided below.

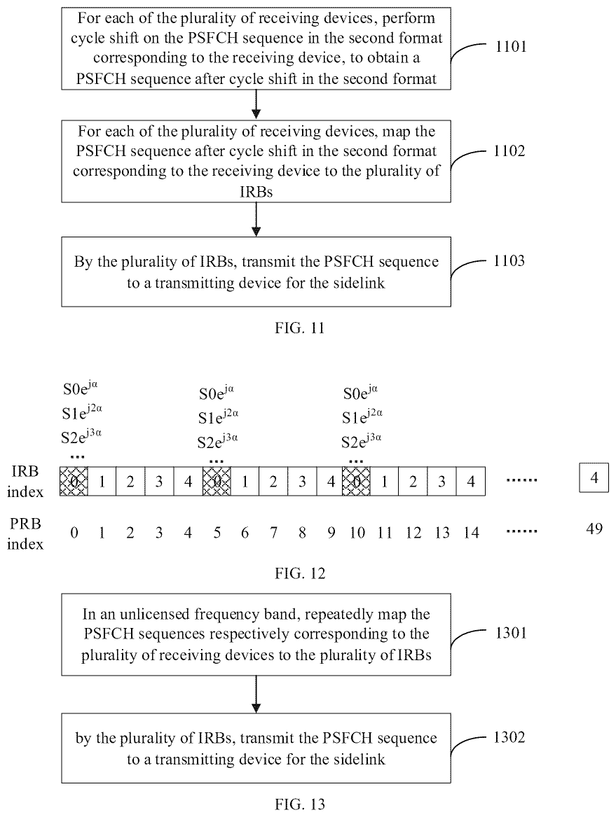

Referring to FIG. 12, assuming M is 5, at 10 IRBs {0, 5, 10, 15, 20, 25, 30, 35, 40, 45} corresponding to IRB index 0, the PSFCH sequence in the second format to be transmitted by receiving device #1 is S0, and after cycle shift, S0 is modulated as S0×e^{jα}. The PSFCH sequence in the second format to be transmitted by receiving device #2 is S1, and after cycle shift, S1 is modulated as S1×e^{j2α}. The PSFCH sequence in the second format to be transmitted by receiving device #3 is S2, and after cycle shift, S2 is modulated as S2×e^{j3α}, and so on.

In the above embodiments, multi-user multiplexing can also be performed for the new PSFCH sequence, which meets the OCB requirement in the unlicensed frequency band of the sidelink, relieves user capacity degradation, and has high availability.

The second method is to repeatedly transmit the PSFCH sequence on each IRB belonging to the same IRB index. The plurality of receiving devices jointly occupy the plurality of IRBs belonging to the same IRB index, where each IRB can be occupied by the PFSCH sequence transmitted by a receiving device.

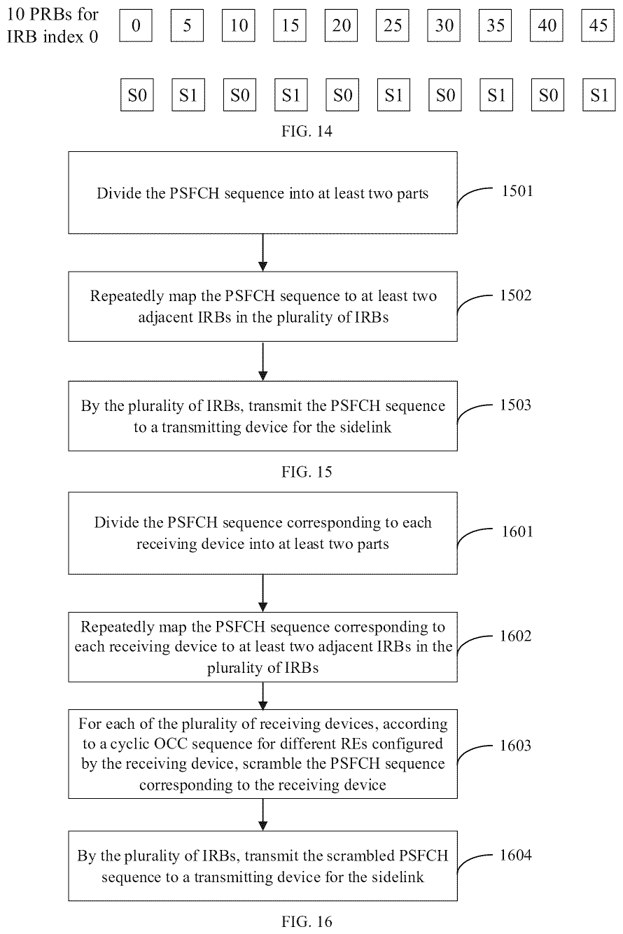

Referring to FIG. 13, FIG. 13 is a flowchart of a channel transmission method according to an embodiment. The method can be performed by a plurality of receiving devices for a sidelink. The method may include the following steps 1301 to 1302.

In step 1301, in an unlicensed frequency band, the PSFCH sequences respectively corresponding to the plurality of receiving devices are repeatedly mapped to the plurality of IRBs.

In the embodiments of the present disclosure, the plurality of IRBs belong to the same IRB index.

In an embodiment, the number of the plurality of IRBs can be 10. Of course, the number of the plurality of IRBs belonging to the same IRB index can also be other values, which is not limited in the present disclosure.

In an embodiment, the PSFCH sequence adopts a first format. The first format is at least used to indicate that a length of the PSFCH sequence is 12. In an embodiment, the first format can refer to format 0.

The plurality of IRBs belonging to the same IRB index are jointly used to transmit PSFCH sequences corresponding to a plurality of the receiving devices, where a PSFCH sequence transmitted by one of the plurality of receiving devices is mapped on at least one IRB in the plurality of IRBs.

In an embodiment, PSFCH sequences corresponding to different receiving devices in the plurality of receiving devices are mapped on adjacent two IRBs in the plurality of IRBs. If the number of receiving devices is R, then the number of IRBs occupied by each receiving device in the 10 IRBs belonging to the same IRB index is

$$[ \frac{10}{R} ] .$$

In step 1302, by the plurality of IRBs, the PSFCH sequence is transmitted to a transmitting device for the sidelink.

For ease of understanding, further examples of the above process are provided below.

As shown in FIG. 14, assuming that M is 5, the number of receiving devices is 2, in the 10 IRBs {0, 5, 10, 15, 20, 25, 30, 35, 40, 45} corresponding to IRB index 0, receiving device #1 occupies IRBs {0, 10, 20, 30, 40} to repeatedly transmit the PSFCH format-0 sequence S0 of receiving device #1, and receiving device #2 occupies IRBs {5, 15, 25, 35, 45} to repeatedly transmit the PSFCH format-0 sequence S1 of receiving device #2.

In the above embodiments, it is possible to meet the OCB requirement in the unlicensed frequency band of the sidelink, and support multiplexing for multiple receiving devices, relieving user capacity degradation and having high availability.

The third method is to divide the PSFCH sequence transmitted by each receiving device and map one PSFCH sequence to at least two adjacent IRBs.

Referring to FIG. 15, FIG. 15 is a flowchart of a channel transmission method according to an embodiment. The method can be performed by a receiving device for a sidelink. The method may include the following steps 1501 to 1503.

In step 1501, the PSFCH sequence is divided into at least two parts.

In an embodiment, the PSFCH sequence adopts a first format. The first format is at least used to indicate that a length of the PSFCH sequence is 12. In an embodiment, the first format can refer to format 0.

In step 1502, the PSFCH sequence is repeatedly mapped to at least two adjacent IRBs in the plurality of IRBs.

In an embodiment, the at least two parts of the PSFCH sequence can be sequentially repeatedly mapped to the at least two adjacent IRBs in the plurality of the IRBs belonging to the same IRB index, where each of the at least two parts is mapped on a plurality of resource elements (REs) of one of the at least two adjacent IRBs. In an embodiment, each of the at least two parts can be mapped to all REs of one IRB.

In step 1503, by the plurality of IRBs, the PSFCH sequence is transmitted to a transmitting device for the sidelink.

In the above embodiments, PSFCH sequence mapping can be performed based on REs, which can also meet the OCB requirement in the unlicensed frequency band of the sidelink, and have high availability.

In some embodiments, referring to FIG. 16, FIG. 16 is a flowchart of a channel transmission method according to an embodiment. The method can be performed by a plurality of receiving devices for a sidelink. The method may include the following steps 1601 to 1604.

In step 1601, the PSFCH sequence transmitted by each receiving device is divided into at least two parts.

In embodiments of the present disclosure, the plurality of the IRBs belonging to the same IRB index are used to transmit PSFCH sequences respectively corresponding to a plurality of the receiving devices. The PSFCH sequence adopts a first format. The first format is at least used to indicate that a length of the PSFCH sequence is 12. In an embodiment, the first format can refer to format 0.

In step 1602, the PSFCH sequence transmitted by each receiving device is repeatedly mapped to at least two adjacent IRBs in the plurality of IRBs.

In an embodiment, the at least two parts of the PSFCH sequence transmitted by each receiving device can be sequentially repeatedly mapped to the at least two adjacent IRBs in the plurality of the IRBs belonging to the same IRB index, where each of the at least two parts is mapped on a plurality of resource elements (REs) of one of the at least two adjacent IRBs. In an embodiment, each of the at least two parts can be mapped to all REs of one IRB.

In step 1603, for each of the plurality of receiving devices, according to a cyclic OCC sequence for different REs configured by the receiving device, the PSFCH sequence transmitted by the receiving device is scrambled.

In step 1604, by the plurality of IRBs, the scrambled PSFCH sequence is transmitted to a transmitting device for the sidelink.

For ease of understanding, further examples of the above process are provided below.

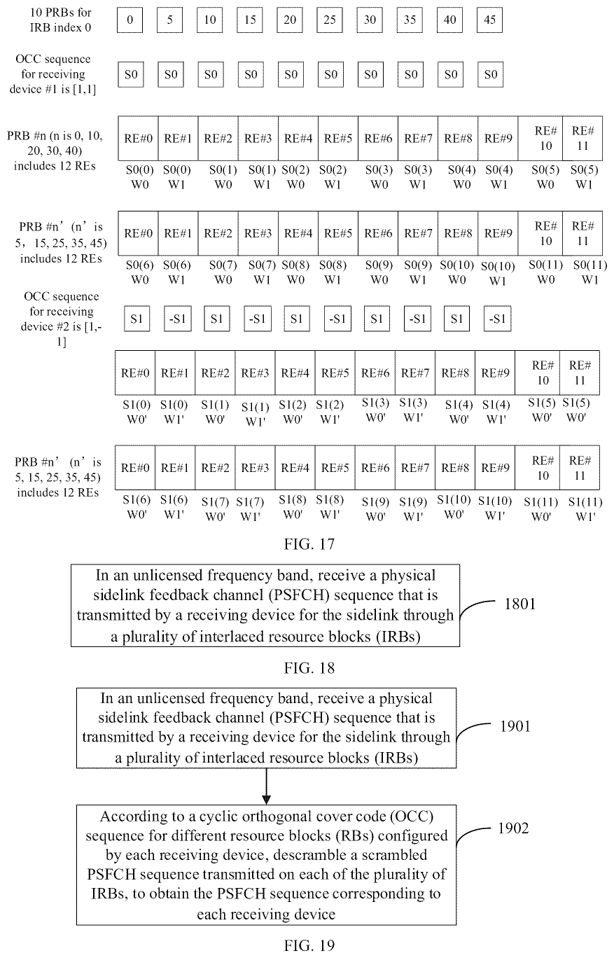

As shown in FIG. 17, the PSFCH format-0 sequence with a length of 12 transmitted by receiving device #1 is S0, specifically {S0 (0), S0 (1), S0 (2), S0 (3), S0 (4), S0 (5), S0 (6), S0 (7), S0 (8), S0 (9), S0 (10), S0 (11)}. The cycle OCC sequence [w0, w1] for different REs configured by receiving device #1 can be [1, 1]. The PSFCH format-0 sequence with a length of 12 transmitted by receiving device #2 is S1, specifically {S1 (0), S1 (1), S1 (2), S1 (3), S1 (4), S1 (5), S1 (6), S1 (7), S1 (8), S1 (9), S1 (10), S1 (11)}. The cycle OCC sequence [w0′, w1′] for different REs configured by receiving device #2 can be [1, −1].

For receiving device #1, the first part of the PSFCH sequence obtained after scrambling is {S0 (0)×w0, S0 (0)×w1, S0 (1)×w0, S0 (1)×w1, S0 (2)×w0, S0 (2)×w1, S0 (3)×w0, S0 (3)×w1, S0 (4)×w0, S0 (4)×w1, S0 (5)×w0, S0 (5)×w1}. The first part can be transmitted on all REs of the IRB with the PRB index 0 in the IRB index 0. The second part is {S0 (6)×w0, S0 (6)×w1, S0 (7)×w0, S0 (7)×w1, S0 (8)×w0, S0 (8)×w1, S0 (9)×w0, S0 (9)×w1, S0 (10)×w0, S0 (10)×w1, S0 (11)×w0, S0 (11)×w1}, and is transmitted on all REs of the IRB with the PRB index 5 in the IRB index 0.

Similarly, for receiving device #2, the first part of the PSFCH sequence obtained after scrambling is {S1 (0)×w0′, S1 (0)×w1′, S1 (1)×w0′, S1 (1)×w1′, S1 (2)×w0′, S1 (2)×w1′, S1 (3)×w0′, S1 (3)×w1′, S1 (4)×w0′, S1 (4)×w1′, S1 (5)×w0′, S1 (5)×w1′}. The first part can be transmitted on all REs of the IRB with the PRB index 0. The second part is {S1 (6)×w0′, S1 (6)×w1′, S1 (7)×w0′, S1 (7)×w1′, S1 (8)×w0′, S1 (8)×w1′, S1 (9)×w0′, S1 (9)×w1′, S1 (10)×w0′, S1 (10)×w1′, S1 (11)×w0′, S1 (11)×w1′}, and is transmitted on all REs of the IRB with the PRB index 5.

In the above embodiment, in the unlicensed frequency band of the sidelink, through the plurality of IRBs belonging to the same IRB index, PSFCH sequences corresponding to the plurality of receiving devices can be repeatedly transmitted, which meets the OCB requirement, relieves user capacity degradation, and improves the availability of the unlicensed frequency band of the sidelink.

The channel transmission method provided in the embodiments of the present disclosure is introduced from a transmitting device below.

The embodiments of the present disclosure provide a channel transmission method. As shown in FIG. 18, FIG. 18 is a flowchart of a channel transmission method according to an embodiment. The method can be performed by a transmitting device for a sidelink. It should be noted that the transmitting device refers to a data transmitting device. The method may include the following step 1801.

In step 1801, in an unlicensed frequency band, a physical sidelink feedback channel (PSFCH) sequence that is transmitted by a receiving device for the sidelink through a plurality of interlaced resource blocks (IRBs) is received.

In the embodiments of the present disclosure, the plurality of IRBs belong to the same IRB index.

In an embodiment, the number of the plurality of IRBs can be 10. The number of the plurality of IRBs belonging to the same IRB index can also be other positive integer values, which is not limited in the present disclosure.

In an embodiment, the PSFCH sequence adopts a first format. The first format is at least used to indicate a length of the PSFCH sequence, and the length of the PSFCH sequence can be 12. In an embodiment, the first format can refer to format 0.

In the above embodiment, the PSFCH sequence can be repeatedly transmitted through the plurality of IRBs belonging to the same IRB index in the unlicensed frequency band of the sidelink, thereby meeting the OCB requirement and improving the availability of the unlicensed frequency band of the sidelink.

In some embodiments, a phase shift of the PSFCH sequence transmitted on each of the plurality of IRBs is modulated. For each of the plurality of the IRBs, the phase shift can be determined according to a ranking of the IRB in the plurality of IRBs.

The transmitting device can receive the PSFCH sequence transmitted on each IRB according to different phase shifts. The method by which the transmitting device determines the phase shift is similar to the method by which the receiving device determines the phase shift, which will not be repeated here.

In the above embodiments, it is possible to meet the OCB requirement in the unlicensed frequency band of the sidelink, and modulate the phase shift for the PSFCH sequence, thereby improving communication performance and having high availability.

In some embodiments, referring to FIG. 19, FIG. 19 is a flowchart of a channel transmission method according to an embodiment. The method can be performed by a plurality of transmitting devices for a sidelink. The method may include the following steps 1901 to 1902.

In step 1901, in an unlicensed frequency band, a physical sidelink feedback channel (PSFCH) sequence that is transmitted by a receiving device for the sidelink through a plurality of interlaced resource blocks (IRBs) is received.

Each of the plurality of IRBs is used to transmit PSFCH sequences corresponding to a plurality of the receiving devices.

In an embodiment, a phase shift of each PSFCH sequence transmitted by the IRB is modulated.

In step 1902, according to a cyclic orthogonal cover code (OCC) sequence for different resource blocks (RBs) configured by each receiving device, a scrambled PSFCH sequence transmitted on each of the plurality of IRBs is descrambled, to obtain the PSFCH sequence transmitted by each receiving device.

A length of the cyclic OCC sequence for different RBs configured by each of the plurality of receiving devices is same as the number N of the PSFCH sequences transmitted on each of the plurality of IRBs.

In the above embodiments, the transmitting device can, according to a cyclic OCC sequence for different RBs configured by each receiving device, descramble PSFCH sequences transmitted on each of the plurality of IRBs, to obtain the PSFCH sequence transmitted by each receiving device. It is possible to meet the OCB requirement in the unlicensed frequency band of the sidelink, modulate the phase shift for the PSFCH sequence, and support multiplexing for the plurality of receiving devices, which reduces user capacity degradation, improves communication performance, and has high availability.

In some embodiments, the PSFCH sequence received by the transmitting device adopts a second format. Specifically, the second format is at least used to indicate that a length of the PSFCH sequence is a preset length, where the PSFCH sequence with the preset length supports being mapped to the plurality of IRBs belonging to the same IRB index.

In an embodiment, the preset length is 120.

The transmitting device can obtain the PSFCH sequence in the second format according to the content transmitted by the plurality of IRBs.

In the above embodiment, it also achieves the goal of meeting the OCB requirement in the unlicensed frequency band of the sidelink, and has high availability.

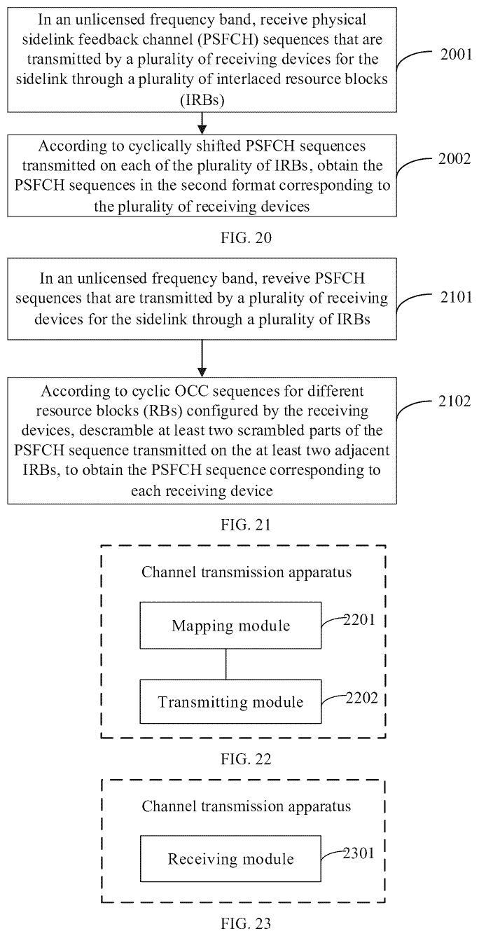

In some embodiments, referring to FIG. 20, FIG. 20 is a flowchart of a channel transmission method according to an embodiment. The method can be performed by a transmitting device for a sidelink. The method may include the following steps 2001 to 2002.

In step 2001, in an unlicensed frequency band, physical sidelink feedback channel (PSFCH) sequences that are transmitted by a plurality of receiving devices for the sidelink through a plurality of interlaced resource blocks (IRBs) are received.

Each of the plurality of IRBs is used to transmit PSFCH sequences in the second format corresponding to the plurality of the receiving devices.

In step 2002, according to cyclically shifted PSFCH sequences transmitted on each of the plurality of IRBs, the PSFCH sequences in the second format corresponding to the plurality of receiving devices are obtained.

In the above embodiments, multi-user multiplexing can also be performed for the new PSFCH sequence, which meets the OCB requirement in the unlicensed frequency band of the sidelink, relieves user capacity degradation, and has high availability.

In some embodiments, the plurality of IRBs belonging to the same IRB index are jointly used to transmit PSFCH sequences corresponding to a plurality of the receiving devices, where a PSFCH sequence transmitted by one of the plurality of receiving devices is mapped on at least one IRB in the plurality of IRBs.

In an embodiment, PSFCH sequences corresponding to different receiving devices in the plurality of receiving devices are mapped on at least two adjacent IRBs in the plurality of IRBs.

The transmitting device can obtain the PSFCH sequence according to the content transmitted by the at least two adjacent IRBs, which is easy to implement and has high availability.

In some embodiments, referring to FIG. 21, FIG. 21 is a flowchart of a channel transmission method according to an embodiment. The method can be performed by a transmitting device for a sidelink. The method may include the following steps 2101 to 2102.

In step 2101, in an unlicensed frequency band, PSFCH sequences that are transmitted by a plurality of receiving devices for the sidelink through a plurality of IRBs are received.

At least two parts of the PSFCH sequence are transmitted on at least two adjacent IRBs in the plurality of IRBs, where each of the at least two parts is mapped on a plurality of resource elements (REs) of one of the at least two adjacent IRBs.

In step 2102, according to cyclic OCC sequences for different resource blocks (RBs) configured by the receiving devices, at least two scrambled parts of the PSFCH sequence transmitted on the at least two adjacent IRBs are descrambled, to obtain the PSFCH sequence transmitted by each receiving device.

In the above embodiment, in the unlicensed frequency band of the sidelink, through the plurality of IRBs belonging to the same IRB index, PSFCH sequences corresponding to the plurality of receiving devices can be repeatedly transmitted, which meets the OCB requirement, relieves user capacity degradation, and improves the availability of the unlicensed frequency band of the sidelink.

Corresponding to the above method embodiments implementing application functions, the present disclosure further provides embodiments of apparatuses for implementing application functions.

Referring to FIG. 22, FIG. 22 is a block diagram of a channel transmission apparatus according to an embodiment, where the apparatus is applied to a receiving device for a sidelink, and includes:
a mapping module 2201, configured to, in an unlicensed frequency band, map a physical sidelink feedback channel (PSFCH) sequence transmitted by the one or more receiving devices to a plurality of interlaced resource blocks (IRBs), where the plurality of IRBs belong to a same IRB index; and
a transmitting module 2202, configured to transmit, by the plurality of IRBs, the PSFCH sequence to a transmitting device for the sidelink.

Referring to FIG. 23, FIG. 23 is a block diagram of a channel transmission apparatus according to an embodiment, where the apparatus is applied to a transmitting device for a sidelink, and includes:
a receiving module 2301, configured to, in an unlicensed frequency band, receive a physical sidelink feedback channel (PSFCH) sequence that is transmitted by a receiving device for the sidelink through a plurality of interlaced resource blocks (IRBs), where the plurality of IRBs belong to a same IRB index.

Since the device embodiments basically corresponds to the method embodiments, the relevant parts can refer to the partial description of the method embodiments. The apparatus examples described above are merely illustrative, where the units described as separate components may or may not be physically separated, and the components displayed as units may or may not be physical units, i.e., may be located in one place or may be distributed to multiple network units. Some or all of the modules can be selected according to the actual needs to achieve the purpose of the technical solutions of the present disclosure. A person skilled in the art can understand and implement without creative work.

Correspondingly, in the present disclosure, a channel transmission device is further provided, and includes:
one or more processors; and
one or more memories storing instructions executable by the one or more processors;
where the one or more processors are configured to perform any one of the above channel transmission methods.

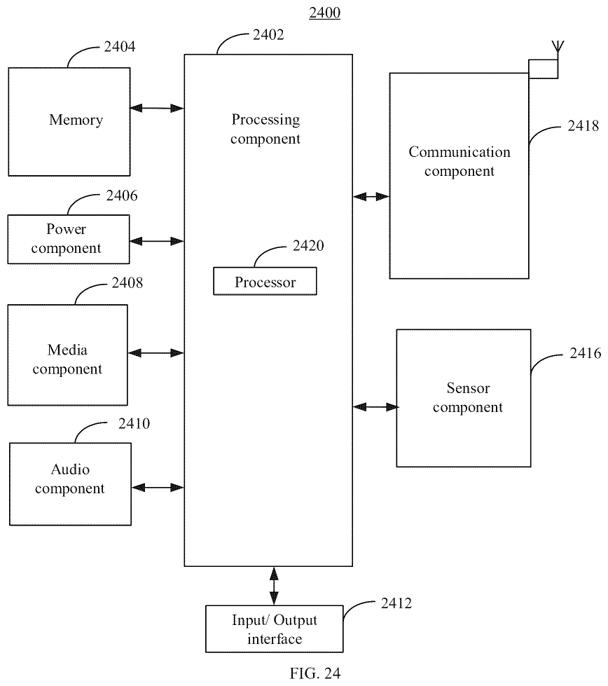

FIG. 24 is a block diagram of a channel transmission device 2400 according to an embodiment. For example, the device 2400 can be a mobile phone, tablet, e-book reader, multimedia playback device, wearable device, car user equipment, iPad, smart TV, unmanned device, and other terminals. The terminal can serve as both the receiving device and the transmitting device for the sidelink.

Referring to FIG. 24, device 2400 can include one or more of the following components: processing component 2402, memory 2404, power component 2406, multimedia component 2408, audio component 2410, input/output (I/O) interface 2412, sensor component 2416, or a communication component 2418.

The processing component 2402 usually controls overall operations of the device 2400, such as operations related to display, a telephone call, data random access, a camera operation and a record operation. The processing assembly 2402 may include one or more processors 2420 to execute instructions to complete all or a part of the steps of the above channel transmission methods. Further, the processing component 2402 may include one or more modules to facilitate interaction between the processing component 2402 and another component. For example, the processing component 2402 may include a multimedia module to facilitate the interaction between the multimedia component 2408 and the processing component 2402. For another example, the processing component 2402 may read executable instructions from the memory to perform steps in the channel transmission method provided in embodiments as described above.

The memory 2404 is configured to store different types of data to support the operations of the electronic device 2400. Examples of such data include instructions of any application program or method operable on the electronic device 2400, contact data, telephone directory data, messages, pictures, videos, and the like. The memory 2404 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or a CD.

The power supply component 2406 provides power for different components of the electronic device 2400. The power supply component 2406 may include a power management system, one or more power sources, and other components associated with generating, managing and distributing power for the electronic device 2400.

The multimedia component 2408 may include a screen for providing an output interface between the electronic device 2400 and a user. In some examples, the multimedia component 2408 may include a front camera and/or a rear camera. When the device 2400 is in an operation mode, such as a shooting mode or a video mode, the front camera and/or the rear camera can receive external multimedia data. Each of the front camera and the rear camera may be a fixed optical lens system or be of a focal length and a capability of an optical zoom.

The audio component 2410 is configured to output and/or input an audio signaling. For example, the audio component 2410 may include a microphone (MIC). When the electronic device 2400 is in an operating mode, such as a call mode, a recording mode and a speech recognition mode, the microphone is configured to receive an external audio signal. The received audio signaling may be further stored in the memory 2404 or transmitted via the communication component 2418. In some examples, the audio component 2410 also includes a loudspeaker for outputting an audio signaling.

The I/O interface 2412 may provide an interface between the processing component 2402 and peripheral interface modules. The above peripheral interface modules may include a keyboard, a click wheel, buttons and so on. These buttons may include but not limited to, a home button, a volume button, a start button and a lock button.

The sensor component 2416 may include one or more sensors for providing state assessments in different aspects for the electronic device 2400. For example, sensor component 2416 can detect an open/closed state of device 2400, a relative positioning of components, such as the display and keypad of device 2400, and sensor component 2416 can also detect a change in position of device 2400 or a component of device 2400, the presence or absence of user contact with device 2400, orientation or acceleration/deceleration of device 2400, and temperature change of device 2400. The sensor component 2416 may include a proximity sensor for detecting the existence of a nearby object without any physical touch. The sensor component 2416 may also include an optical sensor, such as a CMOS or CCD image sensor used in an imaging application. In some examples, the sensor component 2416 may also include an acceleration sensor, a gyro sensor, a magnetic sensor, a pressure sensor, or a temperature sensor.

The communication component 2418 is configured to facilitate wired or wireless communication between the electronic device 2400 and other devices. Device 2400 can access a wireless network according to a communication standard, such as Wi-Fi, 2G, 3G, 4G, 5G, 6G, or any combination thereof. In some embodiments, the communication component 2418 may receive a broadcast signaling or broadcast-related information from an external broadcast management system via a broadcast channel. In an example, the communication component 2418 may also include a Near Field Communication (NFC) module to facilitate short-range communications. For example, the NFC module may be implemented based on a Radio Frequency Identification (RFID) technology, an Infrared Data Association (IrDA) technology, an Ultra-Wideband (UWB) technology, a Bluetooth® (BT) technology and other technologies.

In an example, the device 2400 may be implemented by one or more Application Specific Integrated Circuits (ASIC), Digital Signal Processors (DSP), Digital Signal Processing Devices (DSPD), Programmable Logic Devices (PLD), Field Programmable Gate Arrays (FPGA), controllers, microcontrollers, microprocessors, or other electronic components for performing any one of the channel transmission methods described above.

In an example, a non-transitory computer readable storage medium including instructions, such as the memory 2404 including instructions, is also provided. The above instructions may be executed by the processor 2420 of the device 2400 to complete the above channel transmission method. For example, the non-transitory computer-readable storage medium may be a ROM, a RAM, a CD-ROM, a magnetic tape, a floppy disc, an optical data storage device, and the like.

Other implementations of the present disclosure will be apparent to those skilled in the art from consideration of the specification and practice of the present disclosure herein. The present application is intended to cover any variations, uses, or adaptations of the present disclosure, which follow the general principle of the present disclosure and include common knowledge or conventional technical means in the art that are not disclosed in the present disclosure. The specification and embodiments herein are intended to be illustrative only and the real scope and spirit of the present disclosure are indicated by the following claims of the present disclosure.

It is to be understood that the present disclosure is not limited to the precise structures described above and shown in the accompanying drawings and may be modified or changed without departing from the scope of the present disclosure. The scope of protection of the present disclosure is limited only by the appended claims.

1. A channel transmission method, performed by one or more receiving devices for a sidelink, comprising:
in an unlicensed frequency band, for each of the one or more receiving devices, mapping a physical sidelink feedback channel (PSFCH) sequence transmitted by the receiving device to a plurality of interlaced physical resource blocks (IRBs), wherein the plurality of IRBs belong to a same IRB index; and
transmitting, by the plurality of IRBs, the PSFCH sequence to a transmitting device for the sidelink.

2. The method according to claim 1, wherein mapping the PSFCH sequence transmitted by the receiving device to the plurality of IRBs comprises:
repeatedly mapping the PSFCH sequence on each of the plurality of IRBs, wherein the PSFCH sequence is mapped on each of the plurality of IRBs.

3. The method according to claim 2, further comprising:
modulating a phase shift of the PSFCH sequence mapped on each of the plurality of IRBs.

4. The method according to claim 3, wherein for each of the plurality of the IRBs, the phase shift is determined according to a ranking of the IRB in the plurality of IRBs.

5. The method according to claim 1, wherein the PSFCH sequence is in a first format to indicate a length of the PSFCH sequence.

6. The method according to claim 1, wherein the one or more receiving devices comprise a plurality of receiving devices, each of the plurality of IRBs is used to transmit PSFCH sequences corresponding to the plurality of receiving devices, and the method further comprises:
for each of the plurality of receiving devices, according to a cycle orthogonal cover code (OCC) sequence for different resource blocks (RBs) configured by the receiving device, scrambling the PSFCH sequence transmitted by the receiving device.

7. The method according to claim 6, wherein a length of the cycle OCC sequence for different RBs configured by each of the plurality of receiving devices is same as a number of the PSFCH sequences transmitted on each of the plurality of IRBs.

8. The method according to claim 1, wherein the PSFCH sequence adopts a second format to indicate that a length of the PSFCH sequence is a preset length, wherein the PSFCH sequence with the preset length supports being mapped to the plurality of IRBs belonging to the same IRB index.

9. The method according to claim 8, wherein the preset length is 120.

10. The method according to claim 8, wherein the one or more receiving devices comprise a plurality of receiving devices, each of the plurality of IRBs is used to transmit PSFCH sequences in the second format corresponding to the plurality of receiving devices, and the method further comprises:
for each of the plurality of receiving devices, performing cycle shift on the PSFCH sequence in the second format corresponding to the receiving device to obtain a PSFCH sequence after cycle shift in the second format; and
mapping the PSFCH sequence transmitted by the receiving device to the plurality of IRBs comprises:
for each of the plurality of receiving devices, mapping the PSFCH sequence after cycle shift in the second format corresponding to the receiving device to the plurality of IRBs, wherein one PSFCH sequence is mapped on the plurality of IRBs.

11. The method according to claim 1, wherein the one or more receiving devices comprise a plurality of receiving devices, the plurality of IRBs belonging to the same IRB index are jointly used to transmit PSFCH sequences corresponding to the plurality of receiving devices, wherein the PSFCH sequence transmitted by one of the plurality of receiving devices is mapped on at least one IRB in the plurality of IRBs.

12. The method according to claim 11, wherein PSFCH sequences corresponding to different receiving devices in the plurality of receiving devices are mapped on adjacent two IRBs in the plurality of IRBs.

13. The method according to claim 1, wherein mapping the PSFCH sequence transmitted by the receiving device to the plurality of IRBs comprises:
repeatedly mapping the PSFCH sequence to at least two adjacent IRBs in the plurality of IRBs.

14. The method according to claim 13, further comprising:
dividing the PSFCH sequence into at least two parts; and
repeatedly mapping the PSFCH sequence to at least two adjacent IRBs in the plurality of IRBs comprises:
sequentially repeatedly mapping the at least two parts of the PSFCH sequence to the at least two adjacent IRBs in the plurality of the IRBs belonging to the same IRB index, wherein each of the at least two parts is mapped on a plurality of resource elements (REs) of one of the at least two adjacent IRBs.

15. The method according to claim 14, wherein the one or more receiving devices comprise a plurality of receiving devices, the plurality of the IRBs belonging to the same IRB index are used to transmit PSFCH sequences corresponding to the plurality of receiving devices, and the method further comprises:
for each of the plurality of receiving devices, according to a cycle OCC sequence for different REs configured by the receiving device, scrambling the PSFCH sequence transmitted by the receiving device.

16. A channel transmission method, performed by a transmitting device for a sidelink, comprising:
in an unlicensed frequency band, receiving a physical sidelink feedback channel (PSFCH) sequence that is transmitted by a receiving device for the sidelink through a plurality of interlaced physical resource blocks (IRBs), wherein the plurality of IRBs belong to a same IRB index.

17. The method according to claim 16, wherein a phase shift of the PSFCH sequence transmitted on each of the plurality of IRBs is modulated.

18. The method according to claim 17, wherein for each of the plurality of the IRBs, the phase shift is determined according to a ranking of the IRB in the plurality of IRBs.

19.-29. (canceled)

30. A channel transmission device, comprising:
one or more processors; and
one or more memories storing instructions executable by the one or more processors;
wherein the one or more processors are configured to:
in an unlicensed frequency band, for each of one or more receiving devices, map a physical sidelink feedback channel (PSFCH) sequence transmitted by the receiving device to a plurality of interlaced physical resource blocks (IRBs), wherein the plurality of IRBs belong to a same IRB index; and
transmit, by the plurality of IRBs, the PSFCH sequence to a transmitting device for the sidelink.

31. A channel transmission device, comprising:
one or more processors; and
one or more memories storing instructions executable by the one or more processors;
wherein the one or more processors are configured to perform the channel transmission method according to claim 16.
